(19) United States
(12) Patent Application Publication
(10) Pub. No.: US 2019/0026554 A1
(43) Pub. Date: Jan. 24, 2019

(54) Multilayer UAS Image Ortho-Mosaics for Field-Based High-Throughput Phenotyping

(71) Applicant: Purdue Research Foundation, West Lafayette, IN (US)

(72) Inventors: Katherine Martin Rainey, West Lafayette, IN (US); Keith Cherkauer, West Lafayette, IN (US); Anthony A. Hearst, Lafayette, IN (US)

(73) Assignee: Purdue Research Foundation, West Lafayette, IN (US)

(21) Appl. No.: 16/040,631

(22) Filed: Jul. 20, 2018

Related U.S. Application Data
(60) Provisional application No. 62/534,906, filed on Jul. 20, 2017.

(51) Int. Cl. G06K 9/00

(52) U.S. Cl. CPC G06K 9/00657

(57) ABSTRACT

Multilayer UAS image ortho-mosaics is used to help remote sensing, agronomy and plant breeding (especially field-based high-throughput phenotyping).

### FIELD OF INVENTION

This disclosure relates to a method of generating multilayer Unmanned Aircraft System (UAS) image ortho-mosaics to do field based high-throughput phenotyping. Particularly, the method generated UAS image ortho-mosaics are used for remote sensing, photogrammetry, image processing and computer vision.

### BACKGROUND

Field-based High-Throughput Phenotyping (HTP) of agronomic research plots is a promising area of research for increasing crop yields to ensure food security (Araus & Cairns, 2014). HTP involves measuring physical characteristics of hundreds to thousands of small plots in experimental crop fields. In this case, the field scale corresponds to a few hectares and the plot scale corresponds to a few square meters (1 ha=10,000 m²). Plots may be used to identify best performing varieties, or for other purposes, such as optimizing management practices. Measuring phenotypes can require excessive manual labor. In addition, phenotypic differences between plots are often subtle, so measurements must be precise. Labor costs and the need for high precision and accuracy are major obstacles to research progress (Araus & Cairns, 2014).

Unmanned Aircraft Systems (UAS) are a promising low-cost platform for collecting plot-scale observations for field-based HTP. They can automatically and rapidly collect hundreds of overlapping frame photos of a crop field from a low altitude. These photos can be stitched into a single image ortho-mosaic (hence referred to as a ‘single-layer mosaic’) using techniques from photogrammetry and computer vision implemented in commercial software such as Pix4Dmapper (Pix4D, Lausanne, Switzerland). Phenotypes for each plot can be extracted from the single-layer mosaic or the frame photos.

So far, researchers have focused on extracting phenotypes from single-layer mosaics. They have reported high measurement accuracies for various phenotypes such as canopy cover and color (Haghighattablab et al., 2016; Shi et al., 2016). However, they have also found that single-layer mosaics are prone to geometric and radiometric distortion caused by image stitching errors and variations in lighting, bi-directional reflectance, and image quality. This is especially true in agricultural terrain that lacks distinct features needed for accurate image stitching.

Image stitching errors cause geometric distortion in single-layer mosaics. This often shows up in mosaics as spatial discontinuities. If these occur within plots, then they can obstruct phenotype measurements related to crop structure. They can also cause row-offset errors, in which a row of plants in a single-layer mosaic is aligned incorrectly with imagery of a neighboring row. If the rows are merged smoothly, then it may be difficult to detect the row-offset error. This problem is exacerbated when single-layer mosaics are generated by blending overlapping frame photos into a single image that appears to be spatially continuous and representative of the scene, as done by default in Pix4Dmapper. In this case, an image of a plot in a single-layer mosaic could appear reliable, but it could actually be composed of some images of the correct plot and some images of neighboring plots. This can mislead researchers to extract data from the wrong plots.

Image stitching errors and variations in lighting, bi-directional reflectance, and image quality cause radiometric distortion in single-layer mosaics. This often shows up in mosaics as discontinuities in brightness, color, and sharpness. If these occur within plots, then they can obstruct phenotype measurements related to crop color. This problem is exacerbated when single-layer mosaics are generated by blending pixel colors from overlapping frame photos. This radiometrically and geometrically distorts objects in areas of image misalignment. In addition, Pix4Dmapper attempts to account for variations in lighting by equalizing contrast throughout its mosaics. However, detailed documentation of its algorithm is not publicly available, so it is difficult to know how it affects pixel colors or how appropriate it is in different contexts.

Researchers have been unable to quantify the impacts of these types of distortion on the precision and accuracy of UAS observations because single-layer mosaics provide only one observation per plot. Researchers need to be aware of these problems, their causes, and remedies before relying on UAS data for field-based HTP and other applications.

Therefore, there remains a need to identify a method to generate image ortho-mosaics with little to no distortion that can be used to monitor small spatial plots in large crop fields.

### SUMMARY OF THE INVENTION

This disclosure provides a method of using unmanned aircraft system (UAS) to generate multilayer ortho-rectified image mosaics for field based high throughput phenotyping. The method comprising:
identifying at least one spatial plot in a field with crops;
using UAS to take replicated frame photos of crops in said spatial plot;
separately ortho-rectifying replicate images of crops in the plot;
using nearest-neighbor resampling to preserve pixel color values from the raw imagery in the ortho-rectified images;
using ortho-rectified images of plots containing Ground Control Points (GCPs) to ensure that images are correctly labelled and centered on the correct plots (no row-offsets);
tiling the ortho-rectified images to form multilayer mosaics;
analyzing replicate images in said multilayer mosaic to determine the phenotype of the crop in the field.

In some embodiment the aforementioned replicated frame photos are taken at different flight date of crops' growing season.

In some embodiment the aforementioned multilayer mosaics have N layers, where N is the maximum number of replicate images for the plot in any given flight date.

In some embodiment the aforementioned phenotype is soybean canopy cover measurement.

In some embodiment the aforementioned phenotype is color indication.

In some embodiment the aforementioned ortho-rectified images are processed by MatLab.

In some embodiment the aforementioned method is compared to ground-based imagery and single-layer image ortho-mosaics to evaluate improvements in accuracy obtained by using multilayer mosaics.

In some embodiment the aforementioned method is used to evaluate variation and precision by standard deviations of measurements from the multilayer mosaics.

This disclosure further provides a method for automatically correcting row-offset errors by aligning areas of overlap in neighboring plot images and using this information to calculate their relative positions. Propagating relative position calculations from images of plots with Ground Control Points (GCPs) to images of plots without GCPs ensures that all plot images are correctly labelled and centered on the correct plot.

These and other features, aspects and advantages of the present invention will become better understood with reference to the following figures, associated descriptions and claims.

### BRIEF DESCRIPTION OF THE DRAWINGS

FIG. 1. An RGB image ortho-mosaic of the project field site generated using UAS imagery from a single flight date. Analysis focuses on the field experiment outlined in black and a randomly selected plot outlined in red and magnified on the right.

FIG. 2. A single-layer (left) and 20-layer multilayer (right) UAS image ortho-mosaic of the field experiment highlighted in FIG. 1 made from RGB imagery from a single flight date. The selected plot highlighted in FIG. 1 is outlined here in red. At the bottom are magnified images of the selected plot. The single-layer mosaic yields one image of the plot, while the multilayer mosaic yields nineteen replicate images from each frame photo that captured the plot.

FIG. 3. Ortho-rectified UAS images of the selected plot highlighted in FIG. 1 captured on seven days after planting (DAP). Row-offset errors are outlined in red. The number of replicate images varied depending on the amount of image overlap obtained on each flight date.

FIG. 4. RGB (left) and segmented (right) images of the selected plot highlighted in FIG. 1 on seven days after planting from (a) single-layer mosaics (1.5 cm pixel width), (b) representative images from multilayer mosaics (1.5 cm pixel width), and, (c) ground-based nadir-perspective photos (sub-millimeter pixel width). Segmentation was performed using maximum-likelihood classification. Note the color distortion in the single-layer mosaic images.

FIG. 5. Canopy color measurements for the selected plot highlighted in FIG. 1 on seven flight dates from single-layer and multilayer UAS image mosaics.

FIG. 6. Canopy cover measurements for the selected plot highlighted in FIG. 1 on seven flight dates from single-layer and multilayer UAS image mosaics. The ground reference measurements were obtained from ground-based nadir-perspective imagery.

TABLE 1
Canopy color measurements for the selected plot highlighted in FIG.
1 on seven flight dates from single-layer and multilayer mosaics.

| | | Multilayer Mosaic (Hue) | | |
|---|---|---|---|---|
| | | | | Number of |
| Days After | Single-layer | | Standard | Replicate |
| Planting | Mosaic (Hue) | Mean | Deviation | Observations |
| 25 | 23.7 | 20.7 | 0.7 | 9 |
| 28 | 24.1 | 20.8 | 0.8 | 8 |
| 32 | 24.4 | 22.1 | 0.7 | 19 |
| 38 | 24.6 | 21.4 | 0.5 | 11 |
| 43 | 24.7 | 23.4 | 0.2 | 16 |
| 50 | 28.1 | 23.9 | 0.3 | 6 |
| 53 | 27.5 | 24.2 | 0.3 | 9 |

*Hues and standard deviations multiplied by 100 for easier reading.

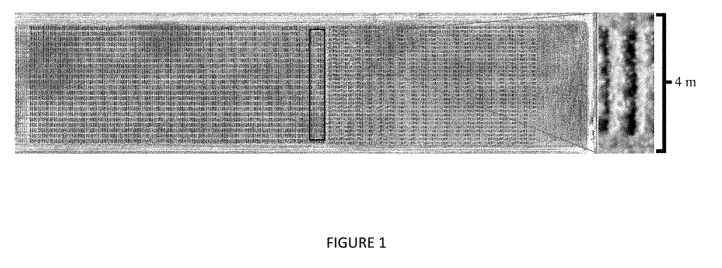

TABLE 2
Canopy cover measurements for the selected plot highlighted
in FIG. 1 on seven flight dates from ground photos, single-
layers mosaics, and multilayer mosaics.

| | | | Multilayer Mosaic (%) | | |
|---|---|---|---|---|---|
| | | | | | Number of |
| Days After | Ground | Single-layer | | Standard | Replicate |
| Planting | Photo (%) | Mosaic (%) | Mean | Deviation | Observations |
| 25 | 10.4 | 20.7 | 14.7 | 0.8 | 9 |
| 28 | 16.4 | 24.3 | 17.6 | 0.6 | 8 |
| 32 | 21.4 | 27.8 | 26.5 | 1.4 | 19 |
| 38 | 35.9 | 47.2 | 37.2 | 0.6 | 11 |
| 43 | 55.1 | 55.6 | 56.4 | 0.9 | 16 |
| 50 | 62.3 | 63.2 | 52.2 | 4.7 | 6 |
| 53 | 72.8 | 67.7 | 56.0 | 8.5 | 9 |

### DETAILED DESCRIPTION

While the concepts of the present disclosure are illustrated and described in detail in the figures and the description herein, results in the figures and their description are to be considered as exemplary and not restrictive in character; it being understood that only the illustrative embodiments are shown and described and that all changes and modifications that come within the spirit of the disclosure are desired to be protected.

Unless defined otherwise, the scientific and technology nomenclatures have the same meaning as commonly understood by a person in the ordinary skill in the art pertaining to this disclosure.

High-Throughput Phenotyping (HTP) of agronomic research plots based on imagery from Unmanned Aircraft Systems (UAS) is a promising area of research for increasing crop yields to ensure food security. Currently, researchers are extracting phenotypes from image ortho-mosaics generated by stitching overlapping frame photos into a single composite image using commercial software such as Pix4Dmapper (Pix4D, Lausanne, Switzerland). These ortho-mosaics are prone to unwanted color modifications by commercial software, as well as geometric and radiometric distortion caused by image stitching errors and variations in lighting, bi-directional reflectance, and image quality. In addition, they provide only one observation per plot, which makes it impossible to quantify measurement precision or apply statistical quality control.

To reduce geometric and radiometric distortion and allow for better quality control, we propose separately ortho-rectifying replicate images of plots from overlapping frame photos using nearest-neighbor resampling. We tile these images to form ‘multilayer mosaics’, in which replicate images of plots are contained in different layers of the mosaic. We demonstrate many advantages of multilayer mosaics by evaluating measurements of two phenotypes—canopy cover and color—for a single research plot of soybean collected on seven flight dates. We find that color modifications by Pix4Dmapper significantly influence canopy color measurements. In addition, geometric and radiometric distortion in Pix4Dmapper's mosaics significantly reduce the accuracy of canopy cover measurements. We also quantify our measurement precision and discuss methods of quality control for enhancing the precision and accuracy of UAS data for field-based HTP.

Instead of using single-layer mosaics, we separately ortho-rectify replicate images of plots from overlapping frame photos using nearest-neighbor resampling. We tile these images to form a new type of ortho-mosaic—a ‘multilayer mosaic’—in which replicate images of plots are contained in different layers of the mosaic. This makes it possible to: 1) improve mosaic fidelity to the raw frame photos, 2) avoid undesired color modification by commercial software, 3) minimize geometric and radiometric distortion caused by image stitching errors, 4) visualize and correct row-offset errors, 5) visualize variations from photo to photo caused by changes in lighting, bi-directional reflectance, and image quality, and, 6) quantify and enhance the precision and accuracy of UAS observations.

Our primary objectives are to illustrate how to produce multilayer mosaics and to evaluate whether they achieve the capabilities listed above. We present a case study to illustrate a methodology for generating multilayer mosaics from overlapping frame photos of a couple of hectares of experimental soybean plots. This imagery was collected at different times during a growing season by a low-flying UAS and processed with Pix4Dmapper and Matlab. We evaluate whether our methodology achieves the capabilities listed above by comparing plot-scale measurements of two phenotypes—canopy cover and color—from single-layer and multilayer mosaics. Replicate measurements from multilayer mosaics and ground reference measurements from ground-based imagery allow us to quantify both the precision and accuracy of our UAS observations. We also measure the frequency of row-offset errors and explain how to correct them. This will help researchers understand the significance of these problems. It will also help researchers understand how to maximize the precision and accuracy of UAS observations so that they may be used for field-based HTP and other applications.

### Methods

The case study was a collaborative research project at Purdue University involving soybean breeders in the Agronomy Department and remote sensing researchers in the Agricultural and Biological Engineering Department. The field site was located at the Purdue University Agronomy Center for Research and Education (ACRE). It consisted of two hectares of experimental soybean planted with a precision plot planter on May 23, 2016 as rectangular arrays of plots classified by row and range numbers. The row orientation was south to north and the row spacing was 76 cm. Each two-row plot was approximately 4 m² in size. For illustration purposes, we focus on imagery of a randomly selected plot from one field experiment (FIG. 1).

The UAS was a small, fixed-wing Precision Hawk Lancaster Mark-III (3 kg total weight, 1.5 m wingspan) equipped with a 14-megapixel Nikon 1-J3 RGB digital camera with manually adjusted aperture, shutter speed, ISO sensitivity, and focus. The UAS stored GPS coordinates for each photo with a horizontal and vertical accuracy of approximately 2 m and 5 m, respectively.

Flights were conducted twice a week from Jun. 3^{rd} to Jul. 5, 2016, resulting in seven sampling dates spanning crop emergence to canopy closure. The UAS was flown 50 m above ground level (AGL) resulting in a spatial resolution of 1.5 cm per pixel. A forward and lateral photo overlap of 70-90% was obtained to allow image stitching and at least four replicate images of every plot.

Imagery was stitched using Pix4Dmapper with default settings for mosaic generation. This produced single-layer mosaics, digital elevation models, and estimates of camera positions and orientations for every photo and flight date. Pix4Dmapper also provided estimates of internal camera parameters for modeling geometric lens distortion. Outputs were horizontally co-registered to the UTM eastings and northings of twenty-five Ground Control Points (GCPs) that were set up in the field before flights and imported into Pix4Dmapper before image stitching.

So far, this methodology has not differed from most published studies. The remaining methods illustrate how we separately ortho-rectify replicate images of plots, visualize and correct row-offset errors, generate multilayer mosaics, measure phenotypes, and evaluate the results.

Researchers in photogrammetry have known for many years that it is possible to remove geometric lens distortion from frame photos and apply a collinearity relationship to trace rays of light from 3D coordinates in the scene to their corresponding 2D coordinates in the frame photos (e.g. Mikhail, 1974). In this case, if we obtain map coordinates of the plots (UTM easting, northing, and altitude) from the single-layer mosaics and digital elevation models, then we may apply collinearity to the camera positions and orientations and internal camera parameters to locate the plots in the frame photos and extract ortho-rectified images of each plot.

The map coordinates of the plots were obtained as follows. First, we segmented a single-layer mosaic into green vegetation and background using the Excess Green Index (ExG) and Otsu thresholding (Otsu, 1979; Woebbecke et al., 1995). Then, we gridded the segmented mosaic into individual plots using a custom algorithm implemented in Matlab. This gave us image coordinates for every plot in the single-layer mosaic. We used the appropriate affine transformation to convert these image coordinates into UTM eastings and northings (Hearst & Cherkauer, 2015). These eastings and northings were valid for every flight date due to horizontal image co-registration. Plot altitudes were obtained from the digital elevation models.

Once we had the map coordinates of the plots, we applied collinearity to the camera positions and orientations and internal camera parameters from each flight date to locate the plots in the frame photos and separately ortho-rectify replicate images of each plot. Ortho-rectification calculations were performed in Matlab using nearest-neighbor resampling to preserve pixel colors from the raw frame photos.

Small errors in horizontal image co-registration and image stitching led to small spatial offsets from the correct plot locations when collinearity was used to extract plots from the frame photos. Sometimes these spatial offsets were large enough to cause images to be centered on the wrong plot. These row-offset errors could be visualized by inspecting the replicate images of the plots and determining whether they contained the correct plot.

To correct row-offset errors, we ortho-rectified each plot image with sufficient spatial padding around its edges to capture the plot and all eight of its nearest neighbors. Then, we used patch matching to align overlapping portions of neighboring plot images. This allowed us to determine the relative positions of neighboring plots within their respective images. Since image co-registration and stitching were constrained to be accurate to within a couple of centimeters at the GCPs, images that contained GCPs were free of row-offset errors and could be used as reliable reference points for positioning and labelling other plot images. Propagating relative position calculations from images of plots with GCPs to images of plots without GCPs allowed us to ensure that all plot images were correctly labelled and centered on the correct plot.

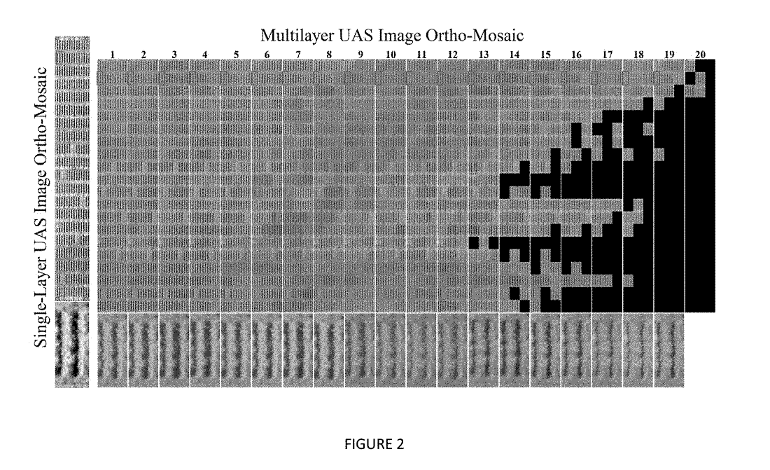

We cropped the plot images to fixed pixel dimensions and saved them in Tiff file format using a file-naming convention that documented the flight date, field experiment, row and range number, and replicate image number for each plot. We grouped the plot images by flight date and field experiment. Then we tiled the images in positions corresponding to their row and range numbers and layered them according to their replicate image numbers to form multilayer mosaics. There was one multilayer mosaic per field experiment per flight date (FIG. 2). Each multilayer mosaic had N layers, where N was the maximum number of replicate images obtained for any plot in that experiment on that flight date.

Ortho-rectifying images of plots of fixed pixel dimensions and tiling them in this manner allowed us to: 1) preserve pixel colors from the raw frame photos, 2) avoid color modifications by Pix4Dmapper, and, 3) minimize geometric and radiometric distortion from image stitching errors. It guaranteed spatial continuity within plots in the mosaic. However, it did not guarantee spatial continuity between plots. This was because the spacing between the plots in the field was not perfectly constant. As a result, small portions of the field near the borders of the plots were either replicated or omitted at the borders between plots in the mosaic.

Ground photos of the selected plot highlighted in FIG. 1 were also collected on every flight date from 4 m AGL at nadir perspective using a 13-megapixel smartphone camera fixed to a pole. Real-time digital video feed from the camera to a smartwatch facilitated manual adjustment of the pole to ensure nadir camera perspective. The ground photos were manually cropped to the same plot areas that were analyzed in the single-layer and multilayer mosaics.

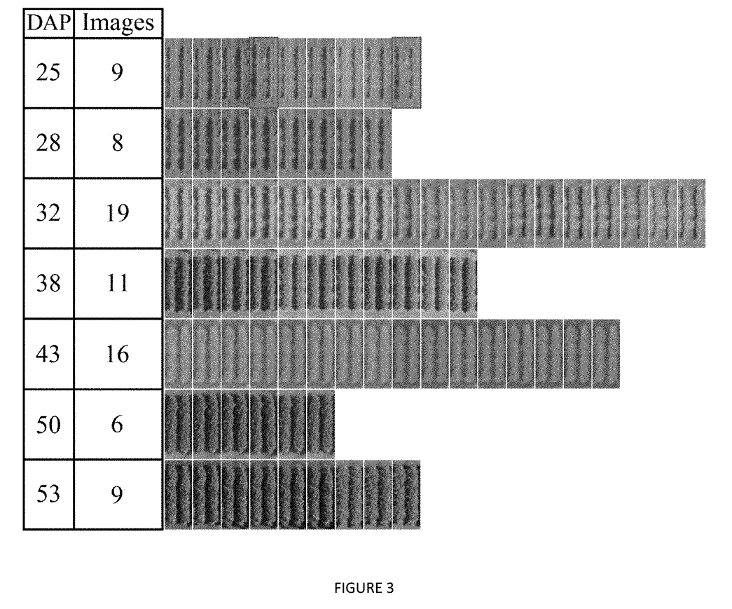

We evaluated row-offset errors by visually inspecting replicate images of the selected plot before and after correcting row-offset errors (FIG. 3). We measured the frequency of row-offset errors on each flight date as the number of offset replicate images divided by the total number of replicate images.

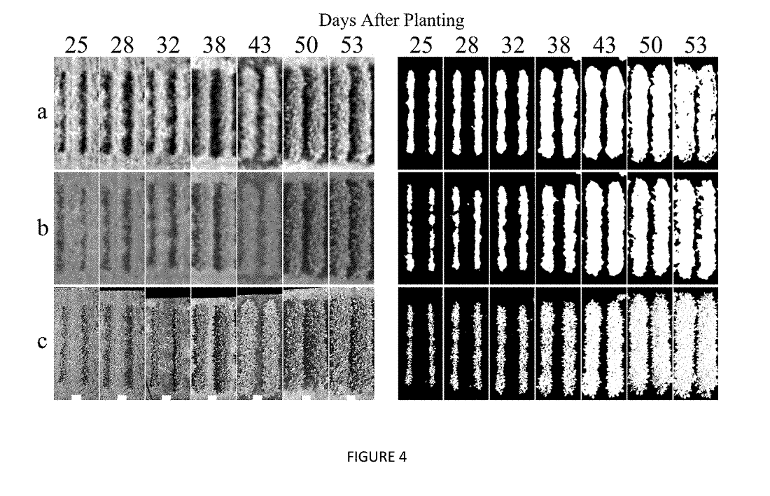

For phenotype measurements, we chose to focus on canopy cover and color because recent studies indicate that they are critical for field-based HTP and can be measured accurately via remote sensing techniques (Normanly, 2012; Xavier et al., 2017). Canopy cover is defined as the fraction of a fixed ground area covered by the canopy (USDA Forest Service, 2010). It is a useful phenotype because it is closely related to light interception and yield (Hall, 2015). For example, the Food and Agriculture Organization (FAO) developed the AquaCrop model to predict yield based on periodic observations of canopy cover instead of Leaf Area Index (LAI—the surface area of leaves per area of ground surface), with the expectation that canopy cover is a reliable indicator of crop status that can be more easily and accurately measured via remote sensing techniques (Steduto et al., 2009). We measured canopy cover as the fraction of canopy pixels in each plot image based on maximum-likelihood classification (FIG. 4).

Canopy color is also a useful indicator of crop status that has been applied in HTP (Normanly, 2012). Researchers speculate that it can be used to model crop stress, senescence, and maturity (Hatfield et al., 2010; Viña, 2004). Canopy color is determined by its spectral reflectance. It has been characterized using a variety of absolute and relative image-based metrics including spectral vegetation indices and pixel hues. When imagery is not calibrated to absolute units of color such as reflectance, relative color metrics such as pixel hues allow comparison of imagery collected with the same sensor under similar lighting conditions (Hatfield et al., 2010; Normanly, 2012). It was not possible to calibrate our imagery to reflectance due to a lack of documentation of sensor characteristics. Therefore, we measured canopy color as the average hue of all canopy pixels in each plot image and we limited color analyses to relative differences between images from the single-layer and multilayer mosaics.

The primary objective of our analysis was to demonstrate that multilayer mosaics allow researchers to: 1) improve mosaic fidelity to the raw frame photos, 2) avoid undesired color modification by commercial software, 3) minimize geometric and radiometric distortion caused by image stitching errors, 4) visualize and correct row-offset errors, 5) visualize variations in pixel colors from photo to photo caused by changes in lighting, bi-directional reflectance, and image quality, and, 6) quantify and enhance the precision and accuracy of UAS observations. We have already demonstrated the first three capabilities. Therefore, analysis focuses on assessing row-offset errors, visualizing variations in canopy cover and color from photo to photo, and quantifying measurement precision and accuracy.

We used the frequency of row-offset errors to evaluate when and how often they might occur and how significant of a problem they might be. We used the proportion of row-offset errors that were corrected to evaluate the success of our method of detection and avoidance. On this basis, we judged whether further investigation into row-offset errors is warranted.

For canopy color, we evaluated variations from photo to photo using standard deviations of measurements from the multilayer mosaics. We plotted measurements from the single-layer and multilayer mosaics to visualize variations from photo to photo and impacts of color modifications by Pix4Dmapper. We evaluated whether these color modifications significantly influenced canopy color measurements by using t-tests to determine whether measurements from the single-layer and multilayer mosaics were significantly different.

For canopy cover, we evaluated variations from photo to photo and measurement precision using standard deviations of measurements from the multilayer mosaics. We plotted measurements from the ground photos, single-layer mosaics, and multilayer mosaics to visualize variations from photo to photo and impacts of geometric and radiometric distortion in Pix4Dmapper's single-layer mosaics on canopy cover measurements. We evaluated whether this distortion significantly influenced canopy cover measurements by using t-tests to determine whether measurements from the single-layer and multi-layer mosaics were significantly different. Finally, we compared measurements from the single-layer and multilayer mosaics to measurements from the ground photos to evaluate their accuracy. Our results shed light on the quality of UAS data and methods of enhancing its precision and accuracy.

### Results

On the first flight date, two out of nine replicate images of the selected plot were row-offset errors (FIG. 3). There were no row-offset errors on the remaining flight dates. This indicates that row-offset errors can occur, although they might not occur frequently. In addition, since they only occurred on the first flight date, this suggests that row-offset errors are likely to occur in datasets collected near the time of crop emergence. Both of these row-offset errors were successfully corrected by propagating relative position corrections from plot images containing GCPs to plots images without GCPs. This indicates that row-offset errors can be automatically detected and avoided when GCPs are available. A more thorough evaluation of the frequency of row-offset errors and methods of detection and avoidance is warranted.

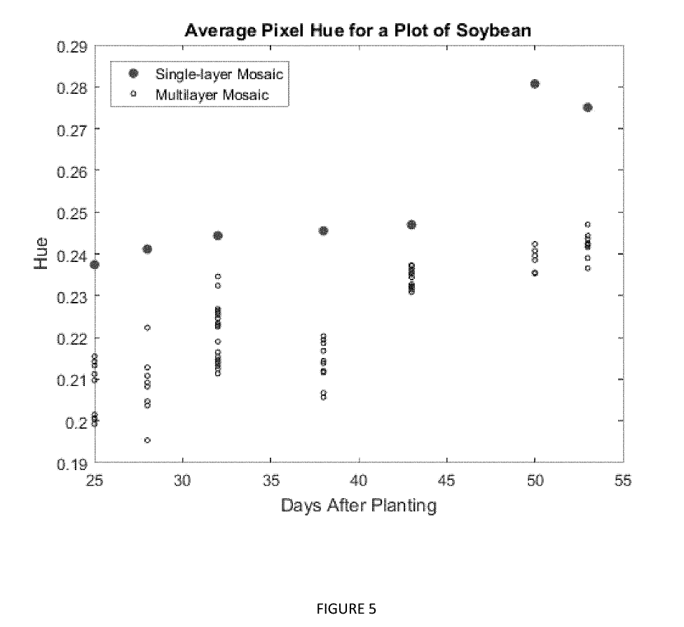

The small standard deviations of canopy color measurements from the multilayer mosaics reflect the small variations in canopy color from photo to photo that were expected due to changes in lighting, bi-directional reflectance, and camera focus (Table 1). Measurements from the single-layer mosaics were always of a higher hue than those from the multilayer mosaics (FIG. 5) and t-tests indicate that they were significantly different (p<0.001 for every flight date) (Table 1). These color differences are clearly visible in the plot images (FIG. 4). Since the variations from photo to photo were so small, these large color differences can be attributed primarily to color modifications by Pix4Dmapper. In other words, color modifications by Pix4Dmapper significantly influenced canopy color measurements. Apparently, Pix4Dmapper has a tendency to increase canopy pixel hues.

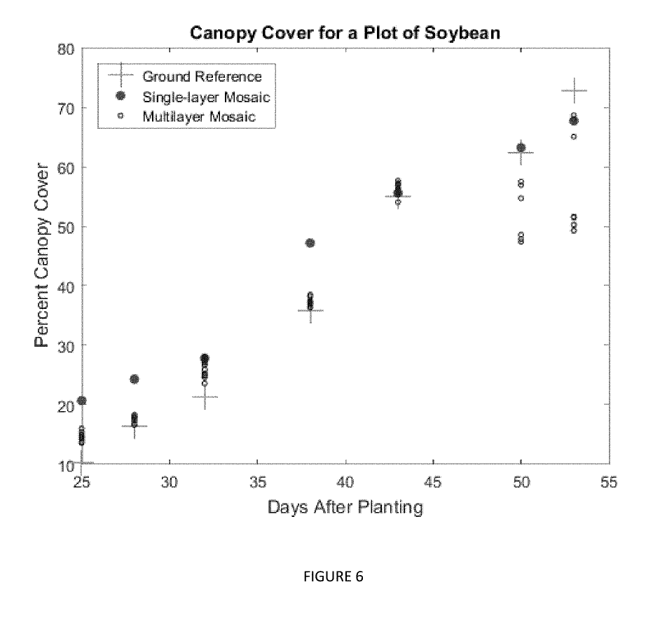

On the first five flight dates, the small standard deviations of canopy cover measurements from the multilayer mosaics reflect the small changes in canopy cover from photo to photo that were expected due to changes in wind, lighting, shadowing, and viewing angle. They indicate that these measurements had a precision of approximately ±3% cover (Table 2). Canopy cover measurements from the single-layer mosaics were almost always higher than those from the multilayer mosaics (FIG. 6) and t-tests indicate that they were significantly different (p<0.01 for every flight date except the third and fifth dates), often by more than 6% cover (Table 2). Since the variations from photo to photo were so small, these large differences in canopy cover can be attributed primarily to geometric and radiometric distortion in Pix4Dmapper's single-layer mosaics. In other words, geometric and radiometric distortion in Pix4Dmapper's single-layer mosaics significantly influenced canopy cover measurements. Apparently, the software has a tendency to increase canopy cover measurements.

Visual inspection of the ground photos confirms that they were of a sufficient quality to provide accurate reference measurements of canopy cover (FIG. 4). On the first five flight dates, measurements from the multilayer mosaics were usually closer to the reference values than those from the single-layer mosaics (FIG. 6). Their means were within 5% cover of the reference values (Table 2). These results indicate that multilayer mosaics usually provide more accurate measurements of canopy cover than single-layer mosaics.

However, on the last two flight dates, measurements from the multilayer mosaics had unusually large standard deviations (precisions of approximately ±20% cover) and low means (approximately 10% below the reference values) (Table 2). Visual inspection of replicate images of the plot from these flight dates (FIG. 3) reveals that these reductions in precision and accuracy were caused by variable shadowing due to a low sun angle at the time of flights.

There do not appear to be any other published studies on row-offset errors. This study confirms that they occur, although probably not frequently, and it is possible to correct them using GCPs. Further research on row-offset errors and methods of detection and avoidance is recommended.

There are many studies that evaluate the accuracy of UAS observations of canopy cover and color extracted from single-layer mosaics (e.g. Haghighattablab et al., 2016; Shi et al., 2016). However, none quantify the precision of their observations or impacts of geometric and radiometric distortion on their precision or accuracy. There also do not appear to be any studies that quantify the precision of UAS observations of canopy color extracted from frame photos.

Torrez-Sanchez et al. (2014) appear to be the only researchers who have quantified the precision of UAS observations of canopy cover extracted from frame photos. They collected multiple frame photos of wheat plots from 30 m and 60 m altitudes and reported means and standard deviations of various image segmentation techniques. They found that the ExG index with Otsu thresholding produced the most accurate and precise results, achieving a precision of approximately ±7% cover at 30 m altitude. Their results are consistent with those of this study. However, they are only applicable to individual frame photos that are not ortho-rectified or mosaicked. Further research on these topics, with a focus on comparing the precision and accuracy of different methods of measuring canopy cover and color, is recommended.

Some researchers have suggested that using weighted average pixel colors or other methods of color blending in single-layer mosaics might help account for variations in lighting, bi-directional reflectance, and image quality from photo to photo (e.g. Haghighattalab et al., 2016). By allowing us to quantify variations in color from photo to photo, multilayer mosaics will play an important role in investigating this possibility.

Researchers have also attempted to minimize geometric and radiometric distortion in single-layer mosaics by only using pixel colors from the closest frame photo to every point in the scene (e.g. Haghighattalab et al., 2016). Although this preserves raw pixel colors in the mosaic, it does not prevent the possibility of creating spatial discontinuities within plots and it needlessly discards replicate observations. Multilayer mosaics avoid these problems by retaining replicate observations and constraining spatial discontinuities to the borders between plots.

Multilayer mosaics create many new opportunities for evaluating and enhancing the quality of UAS observations. They will help standardize UAS observations by ensuring that all measurements are extracted directly from raw frame photos. This would make it easier to replicate studies. In addition, knowledge of the precision of UAS measurements would facilitate outlier detection and other methods of quality control. For example, in this study, the unusually low and highly variable canopy cover measurements on the last two flight dates were attributed to variable shadowing due to a low sun angle at the time of flights. In such cases, measurement errors might be reduced by using maximum canopy cover measurements. As another example, one could investigate whether or not applying an image-sharpening filter could improve the precision of canopy cover measurements, and one could compare the precision of different methods of measuring canopy cover. Multilayer mosaics could also be used to evaluate different metrics of color or temperature derived from multispectral or thermal imagery.

The ability to quantify the precision of UAS observations also has great practical value. For example, it allows us to calculate how often we need to fly to track canopy expansion, since we know how much growth we can reliably detect and roughly how much growth to expect from day to day. Most importantly, we can now determine whether observed differences between experimental plots are statistically significant.

Multilayer mosaics are more appropriate than single-layer mosaics for field-based HTP and other areas of research in which we wish to monitor large numbers of small spatial plots with as much precision and accuracy as possible. This is because they preserve replicate images of plots in their raw format and avoid much of the geometric and radiometric distortion present in single-layer mosaics. They also allow us to evaluate and enhance the precision and accuracy of UAS observations by correcting row-offset errors, testing different image analysis techniques, and applying outlier detection and other statistical analyses to the results. Multilayer mosaics do not preserve spatial continuity from plot to plot, so single-layer mosaics may still be needed in mapping and other applications where positioning is critical. Hopefully new software or other resources will become available that will make multilayer mosaics available to more researchers.

The primary objective of this study was to introduce multilayer mosaics and demonstrate their advantages over single-layer mosaics. Weaknesses of this study include the inability to calibrate our imagery to reflectance, limiting image analysis to a single randomly selected plot, and only testing one method of quantifying canopy cover and color. Therefore, the results of this study might be dependent on the selected plot and image analysis techniques. A follow up study will address these weaknesses by extending this analysis to more plots, additional flight dates, and multiple methods of measuring canopy cover and color. It will also include a more thorough assessment of row-offset errors and methods of detecting and avoiding them.
Araus J. L., & Cairns J. E. (2014). Field high-throughput phenotyping: the new crop breeding frontier. Trends in Plant Science, 19(1), 52-61. doi: 10.1016/j.tplants.2013.09.008
Haghighattalab A., Peréz L. A., Mondal S., et al. (2016). Application of unmanned aerial systems for high throughput phenotyping of large wheat breeding nurseries. Plant Methods 12(35). doi: 10.1186/s13007-016-0134-6.
Hall P. B. (2015). Quantitative characterization of canopy cover in the genetically diverse SoyNAM population.
Hearst A. A., & Cherkauer K. A. (2015). Extraction of small spatial plots from geo-registered UAS imagery of crop fields. Environmental Practice, 17(3), 178-188. doi:10.1017/S1466046615000162.
Mikhail E. M. (1974). An introduction to photogrammetry. Coherent Optics in Mapping, 45, 47-70. doi:10.1117/12.953952.
Normanly J. (2012). High-throughput phenotyping in plants: methods and protocols. New York: New York: Humana Press.
Otsu N. (1979). A threshold selection method from gray-level histograms. Systems, Man and Cybernetics, IEEE Transactions on, 9(1), 62-66. doi:10.1109/TSMC.1979.4310076
Pix4D. Processed with Pix4Dmapper by Pix4D [computer software]. Lausanne, Switzerland.
Shi Y., Thomasson J. A., Murray S. C., et al. (2016). Unmanned aerial vehicles for high-throughput phenotyping and agronomic research. PLoS ONE 11(7). doi:10.1371/journal.pone.0159781.
Torres-Sánchez J., Peña J. M., de Castro A. I., et al. (2014). Multi-temporal mapping of the vegetation fraction in early-season wheat fields using images from UAV. Computers and Electronics in Agriculture, 103. 104-113. doi:10.1016/j.compag.2014.02.009
USDA Forest Service—Natural Resource Information Service (2010). Field sampled vegetation (FSVeg) common stand exam users guide. Appendix M. Glossary of Terms.
Viña A. (2004). Monitoring maize (Zea mays L.) phenology with remote sensing. Agronomy, 96(4), 1139-1148.
Woebbecke D. M., Meyer G. E., Von Bargen K., et al. (1995). Color indices for weed identification under various soil, residue, and lighting conditions. Transactions of the ASAE, 38(1), 259-269.
Xavier A., Hall B., Hearst A. A., et al. (2016). Genetic architecture of phenomic-enabled canopy cover in Glycine max. Genetics. https://doi.org/10.1534/genetics.116.198713.

1. A method of using unmanned aircraft system (UAS) to generate multilayer ortho-rectified image mosaics for field based high throughput phenotyping, comprising:
identifying at least one spatial plot in a field with crops;
using UAS to take replicated frame photos of crops in said spatial plot;
separately ortho-rectifying replicate images of the crops in the plot;
using nearest-neighbor resampling to preserve pixel color values from the raw imagery in the ortho-rectified images;
using ortho-rectified images of plots containing Ground Control Points (GCPs) to ensure that images are correctly labelled and centered on the correct plots (no row-offsets);
tiling the ortho-rectified images to form multilayer mosaics;
analyzing replicate image in said multilayer mosaic to determine the phenotype of the crop in the field.

2. The method according to claim 1, wherein the replicated frame photos are taken at different flight date of crops' growing season.

3. The method according to claim 1, wherein multilayer mosaics have N layers, where N is the maximum number of replicate images for the plot in any given flight date.

4. The method according to claim 1, wherein the phenotype is soybean canopy cover.

5. The method according to claim 1, wherein the phenotype is color indication.

6. The method according to claim 1, wherein the ortho-rectified images are processed by MatLab.

7. The method according to claim 1 is compared to ground-based imagery and single-layer image ortho-mosaics to evaluate improvements in accuracy obtained by using multilayer mosaics.

8. The method according to claims 4 is used to evaluate variation and precision by standard deviations of measurements from the multilayer mosaics.

9. The method according to claims 5 is used to evaluate variation and precision by standard deviations of measurements from the multilayer mosaics

10. A method for automatically detecting row offset errors comprising aligning areas of overlap in neighboring plot images and using this information to calculate their relative positions; Propagating relative position calculations from images of plots with Ground Control Points (GCPs) to images of plots without GCPs to ensure that all plot images are correctly labelled and centered on the correct plot.
